(19) United States
(12) Patent Application Publication
(10) Pub. No.: US 2018/0370006 A1
(43) Pub. Date: Dec. 27, 2018

(54) COMBUSTION GAS-DRIVEN DRIVING-IN DEVICE

(71) Applicant: Hilti Aktiengesellschaft, Schaan (LI)

(72) Inventors: Tilo DITTRICH, Feldkirch (AT); Norbert HEEB, Buchs (CH); Peter BRUGGMUELLER, Bludesch (AT); Dominik SCHMIDT, Buchs (CH)

(73) Assignee: Hilti Aktiengesellschaft, Schaan (LI)

(21) Appl. No.: 16/061,972

(22) PCT Filed: Dec. 20, 2016
(86) PCT No.: PCT/EP2016/081859

§ 371 Date: Jun. 13, 2018

(30) Foreign Application Priority Data
Dec. 22, 2015 (EP) 15201884.2

(51) Int. Cl. B25C 1/14; B25C 1/18; F16J 15/18; F16J 15/3212

(52) U.S. Cl. CPC B25C 1/143; B25C 1/184; F16J 15/28; F16J 15/3212; F16J 15/181

(57) ABSTRACT

The invention relates to a driving-in device comprising a driving-in piston which is guided in a cylinder for driving a nail element into a workpiece and comprising a combustion chamber which is arranged on the driving-in piston and which can be filled with an ignitable combustion gas mixture. An overpressure of the combustion gas mixture can be generated in the combustion chamber by a charging element, and the driving-in piston is sealed against an inner wall of the cylinder by a first seal during the driving-in movement. The driving-in piston is sealed from the combustion chamber by a second seal, which is loaded axially to a piston axis (A), in a starting position.

The invention relates to a driving-in device, in particular a handheld driving-in device, according to the preamble of claim 1.

EP 1 987 924 A1 describes a chargeable driving-in device, in which a driving-in piston is guided by means of a first, radially protruding seal on an outer cylinder wall. The driving-in piston moreover has a cylindrical projection, using which it engages in a hollow-cylindrical outlet of a combustion chamber which is tapered in relation to the cylinder. A second, radially protruding seal, which presses against an inner wall of the outlet in the radial direction, is arranged on the projection.

It is the object of the invention to specify a driving-in device which enables a high charging pressure of the combustion chamber.

This object is achieved according to the invention for a driving-in device mentioned at the outset by the characterizing features of claim 1. By providing the seal loaded in the axial direction, a well-defined sealing of the combustion chamber can be ensured even in the event of high overpressure and over a relatively long period of time. In this case, the second seal is friction loaded hardly or not at all during a piston movement, which furthermore results in a long service life of the seal. With appropriate design, a further advantage of the seal arrangement according to the invention can be that the second seal forms a stop buffer for the returned piston, and therefore the shockwaves arising during the piston reset are reduced.

An overpressure of the combustion gas mixture in the meaning of the invention is understood as an elevated pressure to increase the driving-in energy. In conventional, non-charged devices, the pressure of the combustion gas mixture is usually also somewhat above an ambient pressure, since the pressurized combustion gas is added to the air under atmospheric pressure in the combustion chamber. In this case, this is only a minor pressure increase. An overpressure in the meaning of the invention is preferably at least 100 mbar, particularly preferably at least 200 mbar above the atmospheric pressure.

An axial load of the second seal is understood in the meaning of the invention as a force application to the seal by a sealing surface, the axial force component of which oriented parallel to the piston axis is at least equal to or greater than a force component perpendicular thereto and oriented radially to the piston axis. The axial force component is preferably at least twice as large, particularly preferably at least three times as large as the radial component.

In one preferred embodiment of the invention, the second seal consists of a polymer, preferably an elastomer. A preferred elastomer can be, for example, a natural rubber, silicone rubber, a fluorinated rubber, or another fluorinated elastomer. Such seals have a high sealing action with good tolerance in relation to soiling or aging of the sealing surfaces.

It is generally advantageously provided that the driving-in piston is held by means of a piston holder in the starting position. The piston holder preferably exerts a defined minimum holding force in the direction of the piston axis on the driving-in piston in this case. This results in a defined contact pressure of the seal with controlled axial contact pressure force. In this way, the permitted overpressure of the combustion chamber, which counteracts the contact pressure force, can be reliably determined. The reliable sealing is therefore predominantly determined by the forces of the piston holder and the combustion chamber overpressure. An aging-related material state of the seal has at most a subordinate influence on the sealing.

In one preferred refinement, the piston holder comprises a magnetic holding element in this case. Such holding elements achieve high holding forces and are hardly subject to mechanical wear. In one simple embodiment, the holding element can exclusively be based on permanent magnets. A stop damping by the second seal during return of the driving-in piston is particularly advantageous in this case, since permanent magnets are generally impact-sensitive. In other embodiments, an arrangement having electromagnets can also be provided.

The second seal can generally advantageously press against a spring-elastic screen on a combustion chamber side. Such a screen can reduce the force application to the seal in a simple manner by way of its elasticity. This enables, for example, an arbitrarily large axial holding force of the driving-in piston, without the seal being overstrained. At the same time, the spring-elastic screen can form an additional stop buffer for the returned driving-in piston, to further reduce occurring shockwaves.

In a first preferred embodiment, the second seal is received fixed in place in relation to the combustion chamber. Such an arrangement enables particularly good shading of the seal in relation to hot combustion gases, and therefore the thermal and chemical stability of the seal used is less critical.

In an alternative embodiment thereto, the second seal is received fixed in place in relation to the driving-in piston. This enables easy maintenance access to the seal.

It is obvious that a driving-in device according to the invention can generally also have multiple axially loaded seals. In this case a seal can be provided both fixed in place in relation to the driving-in piston and also fixed in place in relation to the combustion chamber.

Further advantages and features of the invention result from the exemplary embodiments described hereafter and from the dependent claims.

Several preferred exemplary embodiments of the invention are described hereafter and explained in greater detail on the basis of the appended drawings.

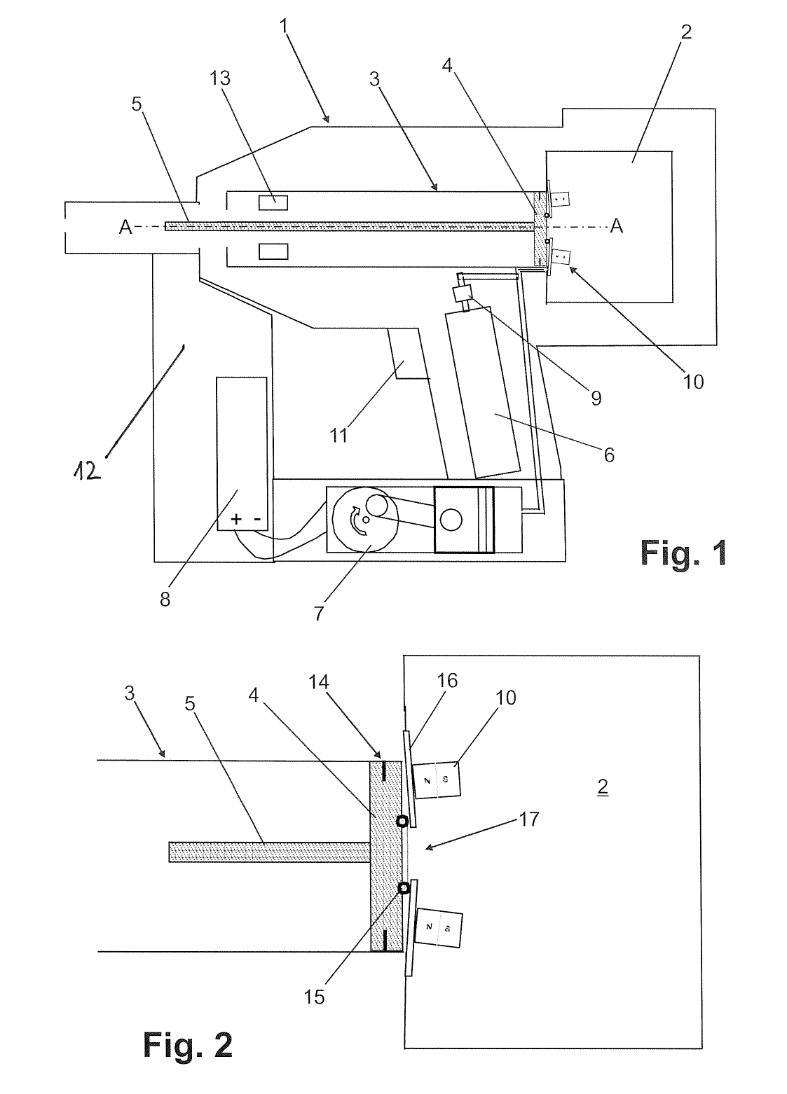

FIG. 1 shows a schematic sectional view of a driving-in device according to the invention of a first exemplary embodiment of the invention.

FIG. 2 shows a detail view of the driving-in device from FIG. 1 before the triggering of a driving-in procedure.

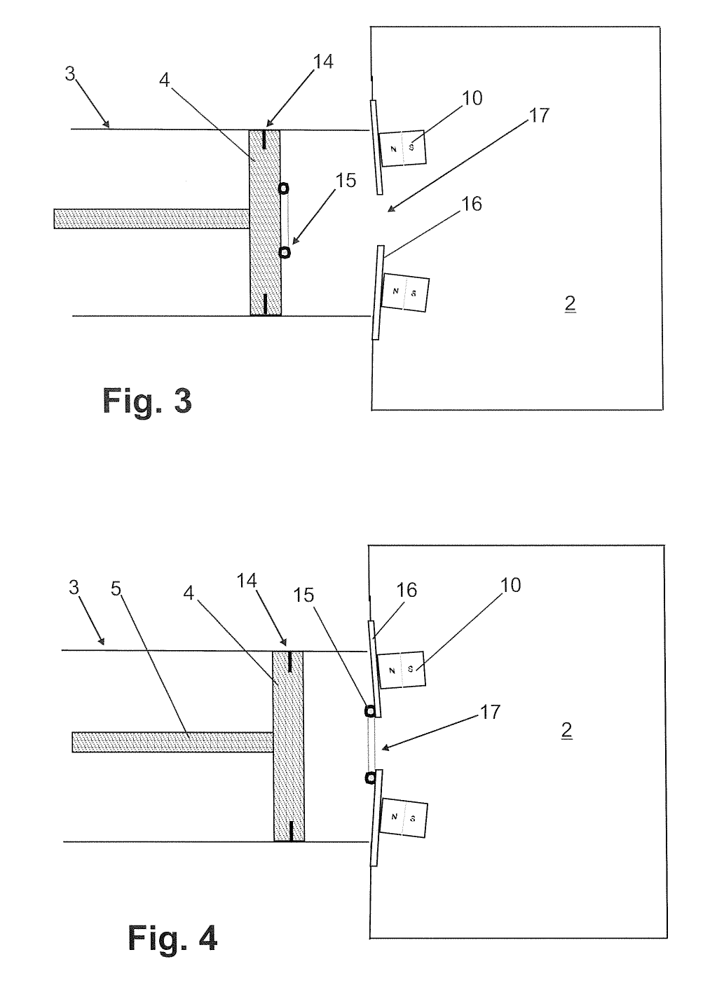

FIG. 3 shows the driving-in device from FIG. 2 during a driving-in procedure.

FIG. 4 shows a detail view of a driving-in device according to a second exemplary embodiment of the invention during a driving-in procedure.

The driving-in device from FIG. 1 is a handheld device, comprising a housing 1 and a combustion chamber 2 accommodated therein having a combustion chamber wall. A cylinder 3 having a driving-in piston 4 guided therein adjoins the combustion chamber 2. The driving-in piston 4 comprises a driving-in tappet 5 for driving a nail element (not shown) into a workpiece.

An ignitable combustion gas mixture is introduced in the present case by means of a combustion gas store 6 and in particular a fresh air inlet (not shown) into the combustion chamber 2. The combustion gas mixture is compressed to an overpressure in this case by means of a charging element 7. The charging element is, for example, designed as an electrically driven compressor supplied via a rechargeable battery 8, which is arranged as an integral component of the driving-in device inside the housing 1. In further embodiments, the charging element is a device separate from the driving-in device. In other embodiments, a charging can also take place by means of a reset of the driving-in piston 4, which is driven in particular by combustion, or in another manner.

The combustion gas is introduced via a metering valve 9 from the combustion gas store 6 into the air of the combustion chamber 2. The combustion gas injection can take place depending on the requirements into the still uncompressed, partially compressed, or also completely compressed air. In the completely reset state (see FIG. 2), the driving-in piston 4 is held by a piston holder in the form of a magnetic holder 10 against the overpressure in the combustion chamber.

With charged combustion chamber, via a hand-actuated trigger 11, an ignition of the combustion gas mixture can be triggered, for example, via a spark plug, and therefore the driving-in piston 4 is driven forward and drives the nail element (not shown) from a magazine 12 into the workpiece via the driving-in tappet 5. The exhaust gases of the ignited and expanded combustion gas can enter the exterior at the end of the path of the driving-in piston via outlet openings 13.

To ensure a sufficient seal of the system, a first seal 14 is provided on the driving-in piston 4, which is supported radially in relation to a piston axis A of the driving-in piston against the inner wall of the cylinder 3. This first seal 14 can consist, for example, of a metal or a hard, thermally and mechanically high-strength plastic such as Torlon (polyamide imide). During the driving-in movement of the driving-in piston 4, the seal slides on the cylinder wall. Because of the short duration of the driving-in procedure, only a relatively moderate leak-tightness of the first seal is required to ensure a sufficiently small pressure loss during the acceleration of the driving-in piston.

To additionally ensure a sufficient sealing of the combustion chamber volume under overpressure before an ignition of the combustion gas mixture, a second seal 15 is moreover provided between the driving-in piston 4 and an outlet opening 16 of the combustion chamber 2.

The second seal 15 is preferably formed as an O-ring made of an elastomer and is loaded in the axial direction with respect to the piston axis A by the driving-in piston 4. The second seal 4 is accommodated on a bottom of the driving-in piston 4, for example, in a ring groove.

A sealing surface for the second seal 15 opposite to the bottom of the driving-in piston 4 is formed in the present case by a screen 16, which forms an outlet opening 17 of the combustion chamber 2. The outlet opening 17 has a smaller diameter than the cylinder 3, and the second seal 15 has a smaller diameter than the first seal 14.

The screen 16 is formed from a defined spring-elastic plate, which is connected in a fixed manner to an extension of the combustion chamber wall. Permanent magnets 10, which form the piston holder for the driving-in piston in the form of a magnetic holder, are arranged on the side of the screen 16 opposite to the driving-in piston 4.

The invention functions as follows:

In the starting position of the driving-in piston 4 according to FIG. 2, an axially oriented holding force is exerted on the driving-in piston 4 by the magnets 10, which is substantially greater than an opposing force exerted by the overpressure in the combustion chamber. In this case, the second seal 15 is pressed by the driving-in piston 4 against the spring-elastic screen 16. The elasticity and/or deformability of the screen 16 improves a secure hold by the magnetic forces and simultaneously prevents an overload of the seal 15.

In this state, an overpressure can be applied to the combustion chamber, wherein a reliable sealing in relation to the exterior is provided by the second seal 15. An arbitrarily long time can pass in principle between the charging and the ignition, in which an operator optimizes the driving-in device in its position or waits for other reasons.

After triggering of the ignition, the holding force of the magnetic holder 10 is overcome by the rising pressure and the driving-in piston is accelerated in the direction of the nail element (see FIG. 3). During this procedure, the expanding combustion gas is only sealed via the first seal 14 in relation to the exterior. In the present example, the second seal 15 is moved along with the driving-in piston, since it is arranged fixed in place thereon. This enables easy maintenance of the seal after removal of the driving-in piston. Under certain circumstances, the achievable energy and thus the driving-in energy of the driving-in piston are increased by the holding back thereof.

In the second exemplary embodiment of the invention shown in FIG. 4, the second seal 15, in contrast to the first exemplary embodiment, is located fixed in place on the cylinder side of the screen 16. This has the advantage, inter alia, that the seal is subjected less to the hot combustion gas stream.

1. A driving-in device, comprising a driving-in piston guided in a cylinder for driving a nail element into a workpiece, the cylinder having an inner wall; and
a combustion chamber, which is fillable with an ignitable combustion gas mixture, arranged on the driving-in piston;
wherein an overpressure of the ignitable combustion gas mixture can be generated in the combustion chamber wherein the driving-in piston is sealed on the inner wall of the cylinder by a first seal during a driving-in movement, and the driving-in piston is sealed in a starting position in relation to the combustion chamber by a second seal, which is loaded axially in relation to a piston axis (A).

2. The driving-in device as claimed in claim 1, wherein the second seal consists of a polymer.

3. The driving-in device as claimed in claim 1, wherein the driving-in piston is held in the starting position by a piston holder.

4. The driving-in device as claimed in claim 3, wherein the piston holder comprises a magnetic holding element.

5. The driving-in device as claimed in claim 1, wherein the second seal presses against a spring-elastic screen on a combustion chamber side.

6. The driving-in device as claimed in claim 1, wherein the second seal is fixed in place in relation to the combustion chamber.

7. The driving-in device as claimed in claim 1, wherein the second seal is fixed in place in relation to the driving-in piston.

8. The driving-in device as claimed in claim 1, wherein the second seal is arranged in a dovetail guide of the piston.

9. The driving-in device of claim 1, wherein the overpressure of the ignitable gas mixture is generated in the combustion chamber by a charging element.

10. The driving-in device of claim 3, wherein the piston holder exerts a defined minimum holding force in the direction of the piston axis (A) on the driving-in piston.

11. The driving-in device as claimed in claim 2, wherein the driving-in piston is held in the starting position by a piston holder.

12. The driving-in device as claimed in claim 11, wherein the piston holder comprises a magnetic holding element.

13. The driving-in device as claimed in claim 2, wherein the second seal presses against a spring-elastic screen on a combustion chamber side.

14. The driving-in device as claimed in claim 3, wherein the second seal presses against a spring-elastic screen on a combustion chamber side.

15. The driving-in device as claimed in claim 4, wherein the second seal presses against a spring-elastic screen on a combustion chamber side.

16. The driving-in device as claimed in claim 2, wherein the second seal is fixed in place in relation to the combustion chamber.

17. The driving-in device as claimed in claim 3, wherein the second seal is fixed in place in relation to the combustion chamber.

18. The driving-in device as claimed in claim 4, wherein the second seal is fixed in place in relation to the combustion chamber.

19. The driving-in device as claimed in claim 5, wherein the second seal is fixed in place in relation to the combustion chamber.

20. The driving-in device as claimed in claim 2, wherein the second seal is fixed in place in relation to the driving-in piston.
